(19) United States
(12) Patent Application Publication
(10) Pub. No.: US 2022/0314928 A1
(43) Pub. Date: Oct. 6, 2022

(54) SYSTEMS AND METHODS FOR DETECTING A DRIVER'S POSITION AROUND OR INSIDE A VEHICLE

(71) Applicant: Rivian IP Holdings, LLC, Plymouth, MI (US)

(72) Inventor: Emmanuel Philosoph, San Jose, CA (US)

(21) Appl. No.: 17/219,936

(22) Filed: Apr. 1, 2021

(51) Int. Cl. B60R 25/01; H04W 4/02; B60R 25/24; H04W 4/48

(52) U.S. Cl. CPC B60R 25/01; H04W 4/023; B60R 25/241; H04W 4/48; B60R 2325/205; B60R 2325/101

(57) ABSTRACT

Disclosed embodiments include systems, vehicles, and methods for selectively activating or deactivating systems associated with an object based on a position of a transmission source relative to the object. In an illustrative embodiment, a system includes signal sensing devices positionable around an object that are configured to detect a transmission signal from a transmission source. A control system is operably coupled with the signal sensing devices. The control system is configured to determine a position of the transmission source relative to the object, the position including an orientation relative to the object and/or a location within a perimeter of the object, based on a relative received signal strength of the transmission signal received by at least one of the signal sensing devices and to initiate operation of at least one subsystem associated with the object based on the position of the transmission source relative to the object.

### INTRODUCTION

Some vehicles are equipped with power locking systems that enable an operator to lock or unlock doors of a passenger cabin with a wireless transmitter housed in a key fob or key handle. In some configurations, the wireless transmitter may be used to unlock only a driver's door instead of unlocking all the doors, or to actually open powered doors. In some configurations, the wireless transmitter may enable an operator to generate a signal to unlock or actually open a trunk or cargo hatch without unlocking or opening doors to the passenger cabin.

### BRIEF SUMMARY

Disclosed embodiments include systems, vehicles, and methods for selectively activating or deactivating systems associated with an object based on a position of a transmission source relative to the object.

In an illustrative embodiment, a system includes a plurality of signal sensing devices positionable around an object. The signal sensing devices are configured to detect a transmission signal from a transmission source. A control system is operably coupled with the plurality of signal sensing devices. The control system is configured to determine a position of the transmission source, the position including an orientation relative to the object and/or a location within a perimeter of the object, based on a relative received signal strength of the transmission signal received by at least one of the plurality of signal sensing devices and to initiate operation of at least one of a plurality of subsystems associated with the object based on the position of the transmission source relative to the object.

In another illustrative embodiment, a vehicle includes a vehicle body. A cabin is configured to receive contents chosen from at least one occupant and cargo. A drive system is configured to motivate, accelerate, decelerate, stop, and steer the vehicle. A proximity response system includes a plurality of signal sensing devices positionable around the vehicle. The signal sensing devices are configured to detect a transmission signal from a transmission source. A control system is operably coupled with the plurality of signal sensing devices. The control system is configured to determine a position of the transmission source relative to the vehicle, the position being chosen from an orientation relative to the vehicle and a location within a perimeter of the vehicle, based on a relative received signal strength of the transmission signal received by at least one of the plurality of signal sensing devices and to initiate operation of at least one of a plurality of subsystems associated with the vehicle based on the position of the transmission source relative to the vehicle.

In another illustrative embodiment, a transmission signal is detected at one or more of a plurality of signal sensing devices, the plurality of signal sensing devices including at least one signal sensing device positioned at a perimeter of a vehicle and one signal sensing device positioned inside of the vehicle. A position of a transmission source of the transmission signal is determined relative to the vehicle, the position being chosen from an orientation relative to the object and a location within a perimeter of the object, based on a relative received signal strength of the transmission signal determined by at the at least one of the plurality of signal sensing devices. Operation of at least one of a plurality of subsystems associated with the vehicle is initiated based on the position of the transmission source relative to the vehicle.

Further features, advantages, and areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way. The components in the figures are not necessarily to scale, with emphasis instead being placed upon illustrating the principles of the disclosed embodiments. In the drawings:

FIG. 1 is a block diagram in partial schematic form of an illustrative system for determining a position of a signal source relative to an object;

FIG. 2 is a block diagram in partial schematic form of an illustrative vehicle configured to determine a position of a signal source relative to the vehicle;

FIG. 3 is a block diagram in partial schematic form of an illustrative vehicle equipped with the system of FIG. 2 and other vehicular subsystems;

FIGS. 4-11 are schematic diagrams of an illustrative vehicle equipped with the system of FIG. 2 to initiate operation of one or more subsystems responsive to the position of the signal source relative to the vehicle;

FIG. 12 is a block diagram of an illustrative computing system for performing functions of the systems of FIGS. 1 and 2;

FIG. 13 is a block diagram of an illustrative network environment in which the systems of FIGS. 1 and 2 are usable; and

FIG. 14 is a flow chart of an illustrative method for initiating one or more vehicle subsystems based on determining a position of a signal source relative to the vehicle.

### DETAILED DESCRIPTION

The following description is merely illustrative in nature and is not intended to limit the present disclosure, application, or uses. It will be noted that the first digit of three-digit reference numbers and the first digit of four-digit reference numbers correspond to the figure number in which the element first appears.

The following description explains, by way of illustration only and not of limitation, various embodiments of enabling verification and/or securing of vehicle insurance to cover temporary use of a vehicle.

By way of a non-limiting introduction and overview, in various embodiments a system is associated with an object, such as a vehicle or another structure, and is used to activate one or more subsystems associated with the object based on determining a position of a transmission source relative to the object. The position determined may include an orientation relative to the object or other structure or a location within a perimeter of the object. For one example, as further described below, when the object is a vehicle, the transmission source may be a key or key fob that is used to unlock and/or operate the vehicle. The vehicle may be equipped with signal sensing devices at locations around the vehicle. Based on signals received by the signal sensing devices, a control system associated with the signal sensing devices determines a position of the signal source based on a relative signal strength detected among the signal sensing devices. Upon determining the position of the transmission source, the control system then may initiate operation of one or subsystems associated with the vehicle. For example, the control system may unlock one or more doors on a side of the vehicle facing the position where the transmission source is detected and/or turn on the interior lights. For another example, when the transmission source is determined to be inside the vehicle, the control system may enable initiation of a drive system of the vehicle or actually activate the drive system and other subsystems of the vehicle. These examples and others, as well as details of the operation of the system, are described below by way of non-limiting examples given by way of illustration only and with reference to the accompanying figures.

Now that a general overview has been given, details of various embodiments will be explained by way of non-limiting examples given by way of illustration only and not of limitation.

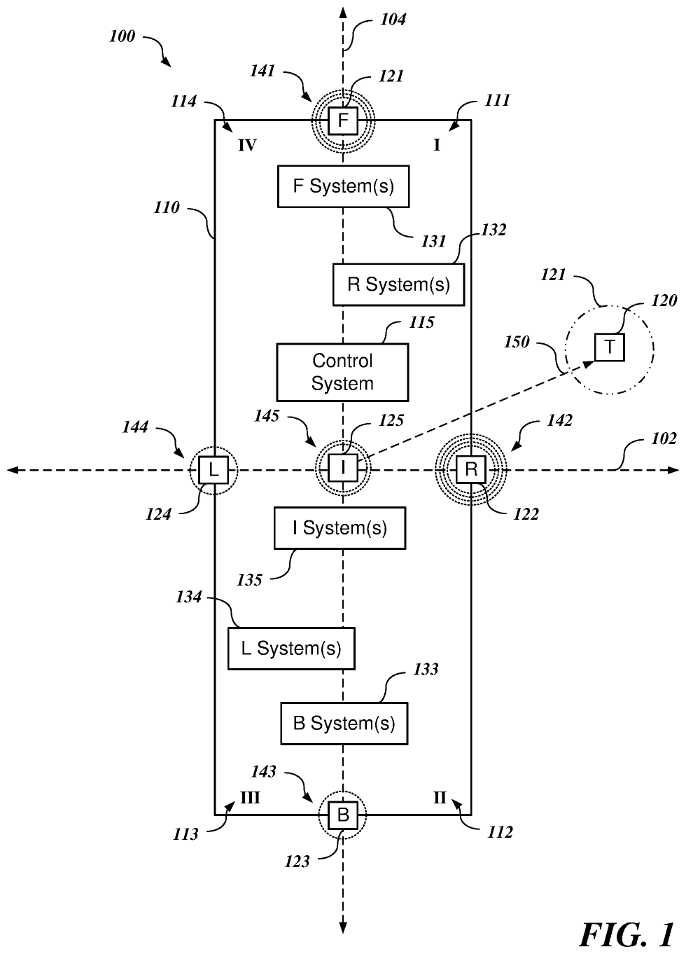

Referring to FIG. 1, in various embodiments a system 100 includes an object 110 in and around which are disposed signal sensing devices 121-125 that are used to determine a position of a transmission source 120 (labelled as “T” in FIG. 1 and other figures) that generates a transmission signal 121 (represented by a sequentially dotted and dashed line in FIG. 1). The signal sensing devices may include digital or analog radio frequency receivers. For example, in various embodiments, Bluetooth radio receivers may be used to receive signals generated by a compatible Bluetooth transmitter. Other communications protocols, such as Wi-Fi protocols under various IEEE 802.11 specifications may be used instead of or in addition to the Bluetooth protocol. The transmission signal 121 may include a coded signal or sequence that indicates that the transmission signal 121 is generated by a device, such as the transmission source 120, that is authorized to access or operate the object 110. The transmission source may include a digital or analog radio frequency transmitter, such as a Bluetooth or Wi-Fi transmitter, that is compatible in frequency transmission range and communications protocol with the signal sensing devices 121-125. It will be appreciated that any form of radio frequency communications may be used in accordance with embodiments disclosed herein, and that Bluetooth and Wi-Fi communications systems are listed by way of illustration and not by way of limitation.

To provide a frame of reference relative to FIG. 1, a horizontal axis 102 and a vertical axis 104 divide an area encompassing the object 110 into four Cartesian quadrants I-IV 111-114, respectively. In the following examples, five signal sensing devices 121-125 are positioned around the object 110. At least a portion of the signal sensing devices, including signal sensing devices 122-125, are positioned around a perimeter of the object. Relative to the frame of reference of FIG. 1, the five signal sensing devices 121-125 include a front signal sensing device 121 (designated as “F” in FIG. 1 and other figures), a right signal sensing device 122 (designated as “R”), a back signal sensing device 123 (designated as “B”), a left signal sensing device 124 (designated as “L”), and an interior signal sensing device 125 (designated as “I”). Although five signal sensing devices 121-125 are used, it will be appreciated that additional signal sensing devices could be used to provide a more granular analysis of the signal strength of the transmission signal 121 to determine a position of the transmission source 120 relative to the object 110, as further described below.

A control system 115 receives inputs from the signal sensing devices 121-125 and, based on a relative signal strength of the transmission signal 121 received from the transmission source 120, determines a position of the transmission source 120 relative to the object 110. The position determined may include an orientation of the transmission source 120 relative to the object 110, such as a determination of which of the quadrants 111-114 in which the transmission source 120 is located relative to the object 110, based on the relative signal strength of the transmission signal 121 detected among the signal sensing devices 121-125. The position determined also may be that the transmission source 120 is at a location within a perimeter of the object 110, based on the relative signal strength of the transmission signal detected by the interior signal sensing device 125 in comparison to the relative signal strength detected by the other signal sensing devices 121-124 positioned toward a perimeter of the object 110. In response to the position of the transmission source 120, the control system 115 may cause one or more subsystems 131-135 to be activated. The subsystems 131-135 include subsystems that may be associated with the signal sensing devices 121-125, respectively, or the relatively associated to a portion of the object 110 where the sensing devices 121-125 are situated. Thus, in the example of FIG. 1, the subsystems include one or more front systems 131 (designated as “F” in FIG. 1 and other figures), one or more right systems 132 (designated as “R”), one or more back systems 133 (designated as “B”), one or more left systems 134 (designated as “L”), and one or more interior systems 135 (designated as “I”).

For example, when the transmission source 120 is located at a vector 150 relative to the axes 102 and 104, the signal sensing devices 121-125 will register different relative signal strengths. The right signal sensing device 122 may perceive a highest signal strength 142 based on a relative nearest proximity of the transmission source 120. The front signal sensing device 121 may perceive a second highest signal strength 141 based on a relative next nearest proximity of the transmission source 120. The internal signal sensing device 125 may perceive a next highest signal strength 145 based on a relative next closest proximity of the transmission source 120. The left signal sensing device 123 and the left signal sensing device 124 may register lower signal strengths 143 and 144, respectively, based on being relative farthest from the transmission source 120. Based on the relative signal strengths 141-145, the control system 115 may determine that the transmission source is in the first quadrant 111 and, thus, may activate subsystems in, nearest to, or associated with the first quadrant 111. Thus, for example, the control system may be configured activate the one or more right systems 132. Alternatively, because of the position of the transmission source 120 is determined to be relatively closer to the right signal sensing device 122 and the front signal sensing device 121, the control system 115 may be configured to activate the one or more right systems 132 and the one or more front systems 131.

The control system 115 also may be configured to activate the one or more right systems 132, the one or more front systems 131, and the one or more internal systems 135. In various embodiments, the control system only initiates operation of one or more of the subsystems when at least one of the signal sensing devices perceives a signal strength at least equal to a minimum threshold, indicating that the transmission source 120 is within a predetermined maximum range of the object.

For further example, if the object 110 includes a home or other building, there may be doors on one or more sides of the building, lights on one or more sides of the building, and lights or climate control systems inside the building. When the transmission source 120 enters the first quadrant 111 toward the right, front side of the building (or the transmission source 120 is selectively activated by a user when approaching the right side of the building), the control system 115 may be configured to unlock a nearest door and turn on the nearest lights. With the transmission source 120 being determined to be proximate to the building, one or more interior lights and a climate control system within the building also may be activated. On the other hand, if the transmission source 120 is determined to be proximate to the back of the building and/or the left side of the building, other doors may be unlocked, other lights turned on, etc. In any case, based on the determination of the location of the transmission source 120 relative to the signal sensing devices 121-125, the control system 115 may selectively activate one or more sets of subsystems 131-135 for the convenience of a holder of the transmission source and/or for the security of the object 110.

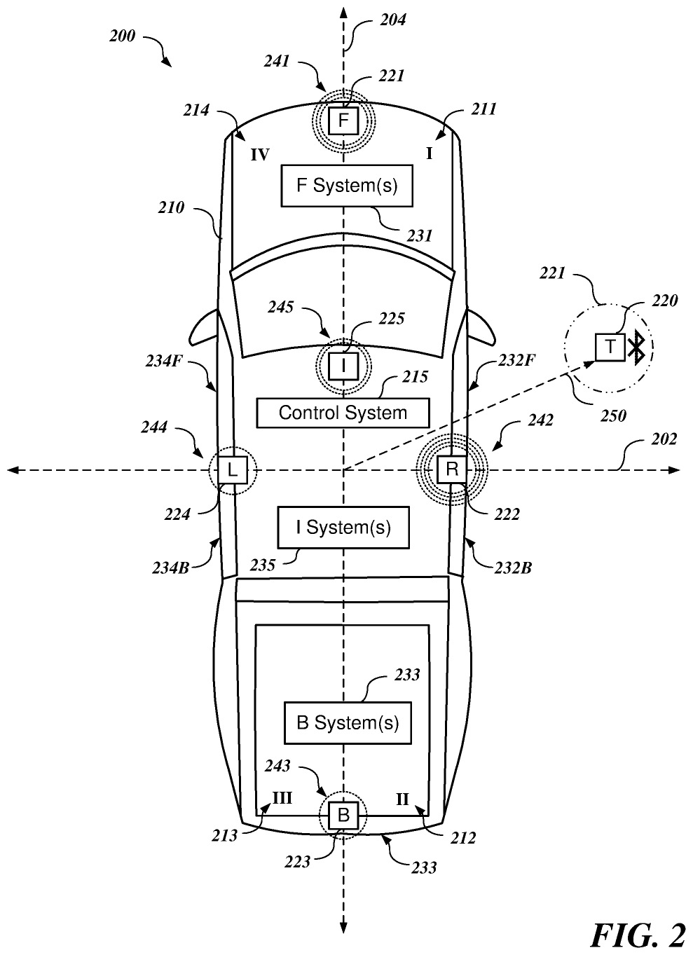

Referring additionally to FIG. 2, a system 200 comparable to the system 100 of FIG. 1 is deployed on a vehicle 210. Signal sensing devices 221-225 are used to determine a position of a transmission source 220 (labelled as “T”) relative to the vehicle 210. The transmission source 220 may include a key or key fob with a transmitter that provides a transmission signal 221 that identifies itself to the signal sensing devices 221-225 and their associated control system 215 as having authority to access the vehicle 210. The transmission source 220 also may include a smartphone, smartwatch, or other portable electronic device operable to generate a signal recognizable to demonstrate authority to access the vehicle 210. In various embodiments, the transmission source 220 and the signal sensing devices 221-225 may be configured to use a Bluetooth communications protocol or some other radio frequency communications.

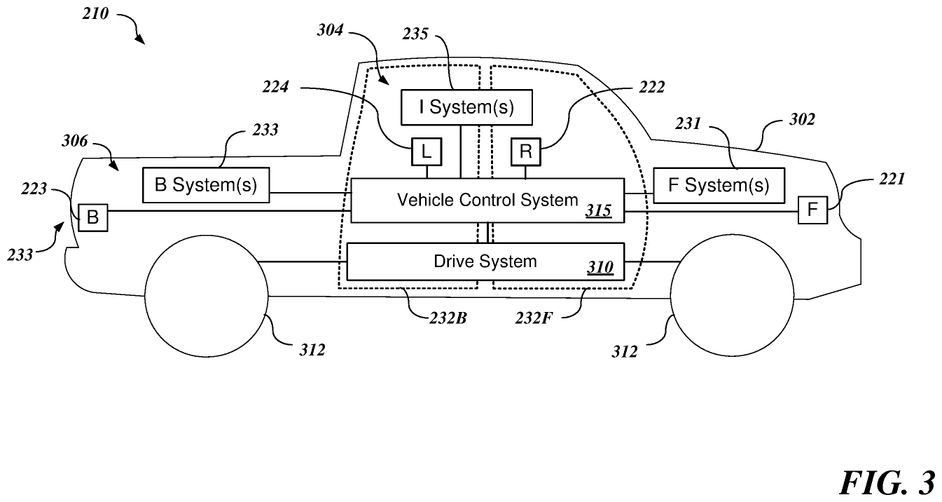

As with FIG. 1, to provide a frame of reference relative to FIG. 2, a horizontal axis 202 and a vertical axis 204 divide an area encompassing the vehicle 210 into four Cartesian quadrants I-IV 211-214, respectively. The vehicle is equipped with five signal sensing devices 221-225, some of which are positioned around a perimeter of the vehicle 210. Relative to the frame of reference of FIG. 2 as well as FIGS. 3-9, the five signal sensing devices 121-125 include a front signal sensing device 121 (designated as “F” in FIGS. 2-9), a right signal sensing device 122 (designated as “R”), a back signal sensing device 123 (designated as “B”), a left signal sensing device 124 (designated as “L”), and an interior signal sensing device 125 (designated as “I”). Although five signal sensing devices 221-225 are used in the example of FIGS. 2-9, as stated with reference to FIG. 1, it will be appreciated that additional signal sensing devices could be used to provide a more granular analysis of the signal strength of the transmission source 220 to determine a position of the transmission source 220 relative to the vehicle 210, as further described below.

A control system 215 receives signals from the signal sensing devices 221-225 and, based on a relative signal strength received from the transmission source T 220, determines a position of the transmission source 220 relative to the vehicle 210. In response to the position of the transmission source 220, the control system 215 may cause one or more subsystems to be activated. In the vehicle 210, the subsystems may include one or more front systems 231 (designated as “F” in FIGS. 2 and 3), one or more back systems 233 (designated as “B”), and one or more interior systems 235 (designated as “I”). By way of illustration and not by way of limitation, the front systems 231 and the rear systems 233 may include exterior lights that illuminate portions of the vehicle 210, such as door handles, running boards, or steps, as well as areas adjacent to those parts of the vehicle 210. The interior systems 235 may include interior lights, climate control systems, and a drive system of the vehicle 210, as further described below. Additional vehicle subsystems include locks on doors of the vehicle 210, which, in various embodiments, includes a right front door 232F, a right back door 232B, a left front door 234F, a left back door 234B, and a rear hatch 233 at a rear of the vehicle 210. Based on a position of the transmission source 220 relative to the vehicle 210, one or more of the subsystems may be activated.

For example, when the transmission source 220 is located at a vector 250 relative to the axes 102 and 104, the signal sensing devices 221-225 will perceive different relative signal strengths emanating from the transmission source 220. The right signal sensing device 222 may perceive a highest signal strength 242 based on a relative nearest proximity of the transmission source 220. The front signal sensing device 221 may perceive a second highest signal strength 241 based on a relative next nearest proximity of the transmission source 220. The internal signal sensing device 225 may perceive a next highest signal strength 245 based on a relative next closest proximity of the transmission source 220. The left signal sensing device 223 and the left signal sensing device 224 may register lower signal strengths 243 and 244, respectively, based on being relative farthest from the transmission source 220. Based on the relative signal strengths 214-245, the control system 215 may determine that the transmission source is in the first quadrant 211 and, thus, may activate subsystems in, nearest to, and/or associated with the first quadrant 211.

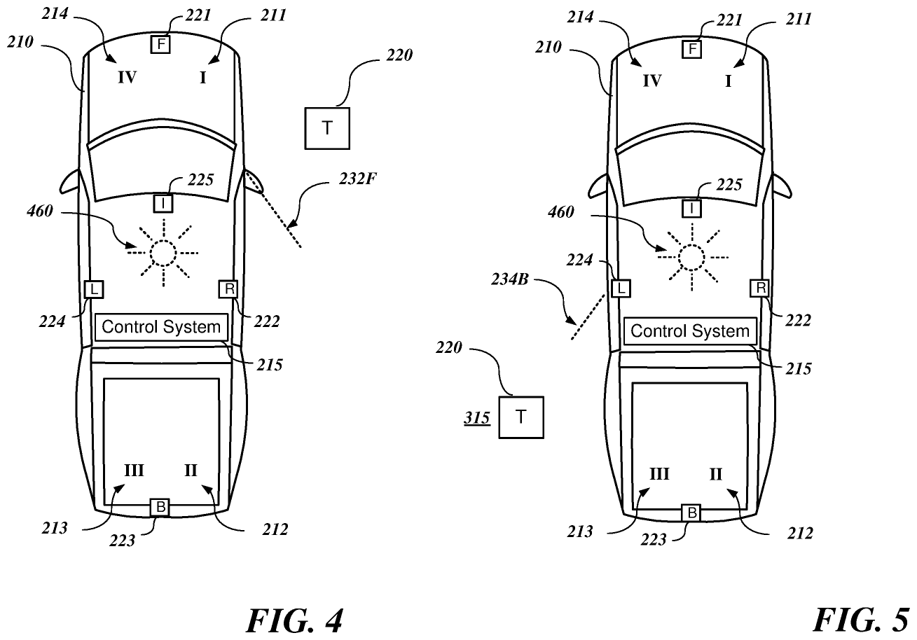

Thus, for example, the control system 215 may direct a power locking system to unlock the right front door 232F (and/or possibly the right back door 232B). The control system 215 also may activate one or more of the interior systems 235, such as interior lights or climate control systems as a result of the approach of the transmission source 120. Thus, if a user (not shown) presents and/or selectively activates the transmission source 120 at the vector 250, the control system 215 will unlock the nearest door or doors and/or turn on lights and other systems for the utility, security, or convenience of the user. As further described below with reference to FIGS. 4-11, depending on the location of the transmission source 220 relative to the vehicle 210, others of the front systems 231, back systems 233, and interior systems 235 may also be activated.

Referring additionally to FIG. 3, the vehicle 210 includes a vehicle body 302 that incorporates a cabin 304 that accommodates a payload that includes occupants and/or cargo. The cabin 304 may be accessible via doors, such as the right front door 232F, the right back door 232B, the left front door 234F (not shown in FIG. 3), and the left back door 234B (not shown in FIG. 3). In various embodiments, the body 302 also includes a cargo area 306 separate from the cabin 304, such as a truck bed or trunk, where additional cargo may be carried. The cargo area 306 may be accessible via one or more cargo hatches 233, such as a tail gate, lift gate, or another hatch. The vehicle 210 also includes a drive system 310 that is operably coupled with wheels 312 to accelerate, decelerate, steer, brake, or otherwise motivate the vehicle 210.

In various embodiments, the vehicle 210 also includes a vehicle control system 315 that controls operation of the vehicle 210 including, but not limited to, controlling the drive system 310. In various embodiments, the vehicle control system 315 also serves as the control system for the signal sensing devices 221-225, the front systems 231, the back systems 233, and the interior systems 235. In various embodiments, the vehicle control system 315 analyzes the relative signal strengths perceived by the signal sensing devices 221-225 and determines which of the subsystems to initiate or engage as a result from among the doors 232F, 232B, 233, 234F, 234B, the front systems 231, the back systems 233, the interior systems 235, and/or the drive system 310, as further described below.

In the context of the vehicle 210 described with reference to FIGS. 2 and 3, FIGS. 4-11 are used to describe examples of the operation of the vehicle control system 315, the signal sensing devices 221-225, the doors 232F, 232B, 233, 234F, 234B, the front systems 231, the back systems 233, the interior systems 235, and/or the drive system 310 in response to determining the position of the signal source 220 relative to the vehicle 210.

Referring additionally to FIG. 4, the transmission source 220 approaches the vehicle 210 toward the first quadrant 211. In various embodiments, as a result of the signal sensing devices 221-225 and the control system 215 determining the transmission source 220 to be in the first quadrant 211, the control system 215 initiates the proximate subsystems by unlocking the right front door 232F. In a vehicle equipped with powered doors, the control system also could actually open the right front door 232F, in addition to unlocking it. In FIGS. 4-9, the unlocking and/or opening of a door is represented by a dotted line indicating access to the door. In addition, in various embodiments the control system may initiate operation of one of the interior systems 235 (FIGS. 2 and 3), such as by turning on interior lights 460.

In various embodiments, when the transmission source 220 moves beyond the range of the signal sensing devices 221-225, complementary operations may be performed to initiate responses opposite to those that are initiated when the transmission source 220 comes into range of the signal sensing devices 221-225. For example, as described with reference to FIG. 4, doors may be unlocked and lights turned on when the transmission source 220 comes within range of the signal sensing devices 221-225. Thus, in some embodiments, when the transmission source 220 moves out of a predetermined range of the signal sensing devices 221-225 such that the signal sensing devices 221-225 do not detect a minimum signal from the transmission source 120, the control system 215 may initiate complementary operations by powering off lights or other systems and/or by locking doors.

Referring additionally to FIG. 5, by contrast, the transmission source 220 approaches the vehicle 210 toward the third quadrant 211. In various embodiments, as a result of the signal sensing devices 221-225 and the control system 215 determining the transmission source 220 to be in the third quadrant 213, the control system 215 initiates the proximate subsystems by unlocking the left back door 234F. In addition, in various embodiments, the control system may initiate operation of one of the interior systems 235 (FIGS. 2 and 3), such as by turning on interior lights 460.

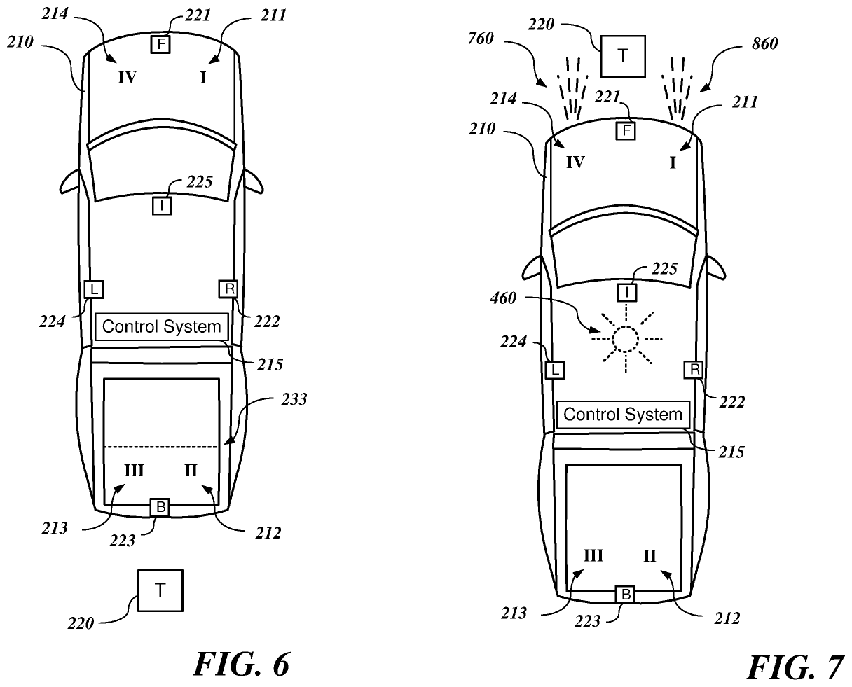

Referring additionally to FIG. 6, the transmission source 220 approaches the vehicle 210 from the back, toward the second quadrant 212 and third quadrant 213. In various embodiments, as a result of the signal sensing devices 221-225 and the control system 215 determining the transmission source 220 to be between the second quadrant 212 and the third quadrant 213, the control system 215 initiates the proximate subsystems by unlocking or opening the rear hatch 233. In addition, in various embodiments, the control system may initiate operation of one of the back systems 233 (FIGS. 2 and 3), such as by turning on cargo area lights (not shown in FIG. 6).

Referring additionally to FIG. 7, the transmission source 220 approaches the vehicle 210 from the front, toward the first quadrant 211 and fourth quadrant 214. In various embodiments, as a result of the signal sensing devices 221-225 and the control system 215 determining the transmission source 220 to be between the first quadrant 211 and the fourth quadrant 214, the control system initiates the proximate subsystems by engaging a portion of the front systems 231 (FIGS. 2 and 3) by turning on front lights 760 to illuminate the area for the user. In various embodiments, the control system may also initiate part of the interior systems 233 by turning on the interior lights 460.

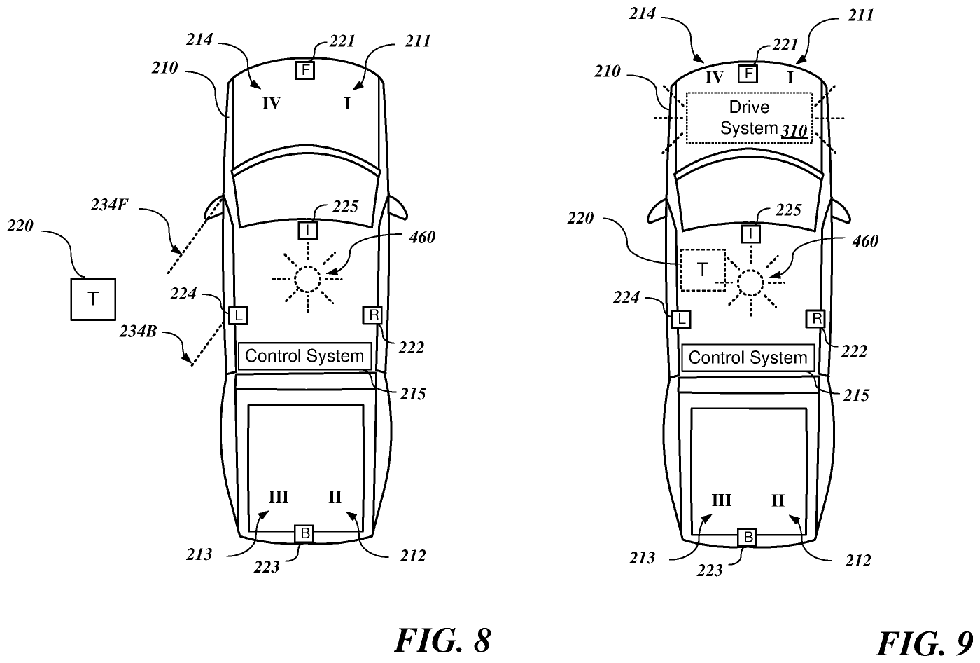

Referring additionally to FIG. 8, the transmission source 220 approaches the vehicle 210 from the left, toward the third quadrant 213 and fourth quadrant 214. In various embodiments, as a result of the signal sensing devices 221-225 and the control system 215 determining the transmission source 220 to be between the third quadrant 213 and the fourth quadrant 214, the control system 215 initiates the proximate subsystems by unlocking or opening both the left front door 234F and the left back door 234B. In various embodiments, the control system 215 may also initiate operations of at least some of the interior systems 233 by turning on the interior lights 460.

With reference to FIGS. 4-8, it will be appreciated that, in various embodiments, the control system may be configured to unlock and/or open combinations of doors and/or initiate operation of one or more systems based on relative assessment of the signal strengths perceived by the signal sensing devices 221-225 as well as user preferences as to which systems are initiated. The control system also may be responsive to time or day and/or daylight conditions to determine whether to turn on interior or exterior lights. As further described below, the control system also may be configured to enable or activate the drive system 310 of the vehicle. It will be appreciated that, as the transmission source 220 moves around the vehicle 210, moving between the quadrants 211-214, or moves inside the vehicle 210, the control system may initiate other subsystems to perform other actions.

Referring additionally to FIG. 9, the relative signal strength perceived by the signal sensing devices 221-225 may indicate that the transmission source 220 has been taken inside the cabin 304 (FIG. 3) of the vehicle 210. With the transmission source 220 inside the vehicle 210, rather than unlocking doors, the control system may direct others of the interior systems 235 (FIGS. 2 and 3) or enable or turn on the drive system 310. Thus, in various embodiments, upon a user bringing the transmission source 120 into the vehicle 210, the control system 215 may power on the drive system 310 and/or enable the user to turn on the drive system 310 with a button. In various embodiments, activation of the drive system 310 may not occur until the signal strength perceived by the signal sensing devices 221-225 indicates that the transmission source 220 is actually within the vehicle 210, rather than adjacent to the vehicle 210.

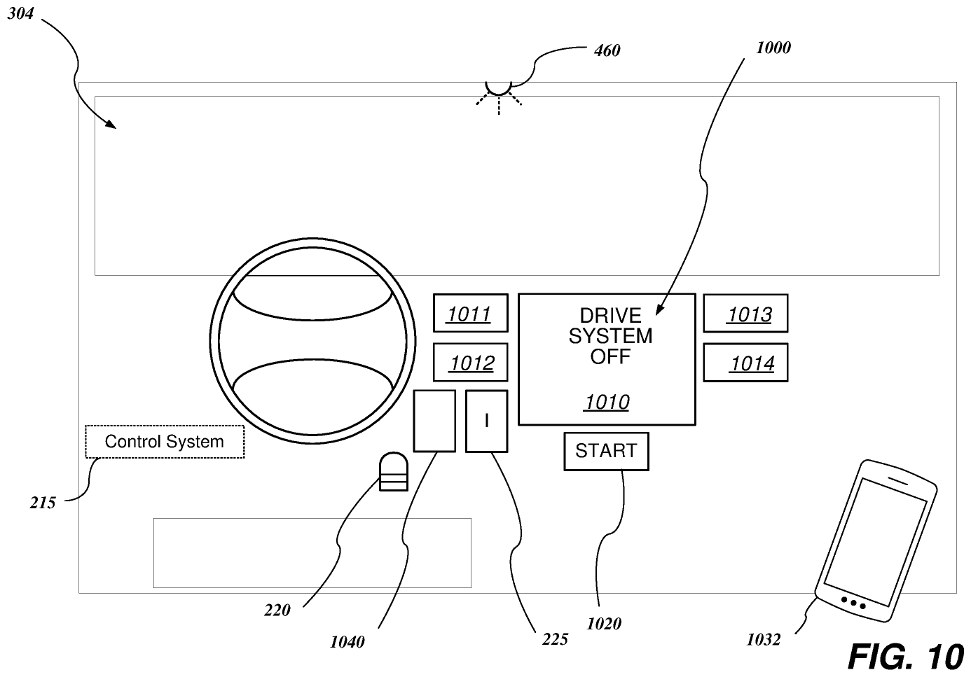

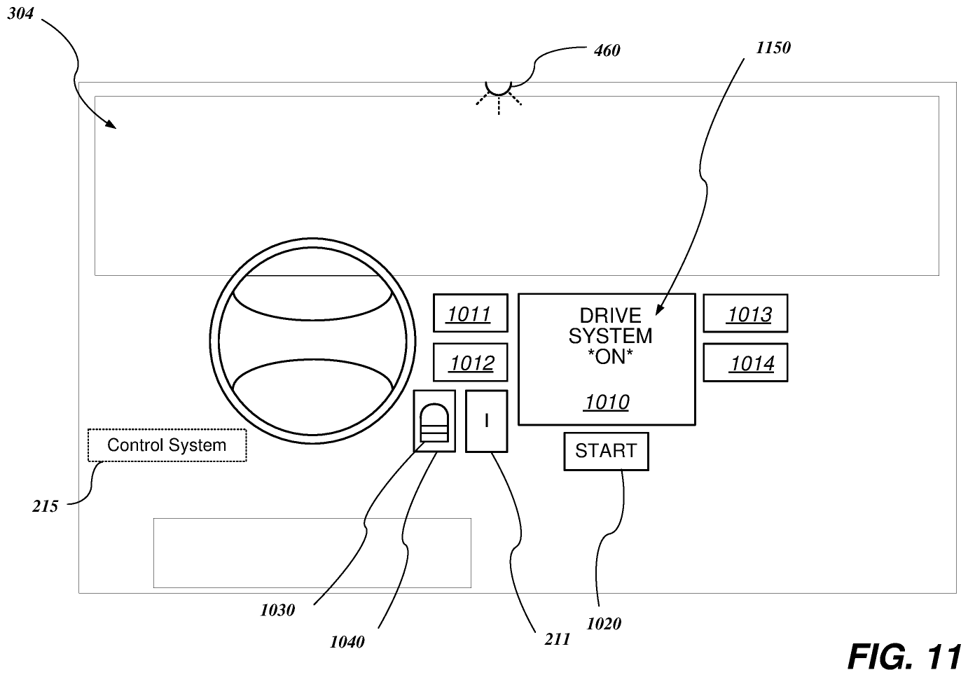

Referring additionally to FIGS. 10 and 11, it will be appreciated that the system may initiate different actions depending on specifically where inside the cabin 304 of the vehicle 210 the transmission source 220 is positioned. In various embodiments, the cabin 304 may include an interface 1000 to the vehicle control system 315 (FIG. 3) including a display 1010, various input controls 1011-1014, and a start button 1020 to power on the drive system 310 (FIG. 3). When the transmission source 220 is determined to be within the cabin by the signal sensing devices 221-225 and the control system (not shown in FIG. 10 or 11), a user may be able to engage the start button 1020 to power on the drive system 310. On the other hand, because of the multiple signal sensing devices 221-225 being able to determine a position of the transmission source 220, the control system 215 may prevent the user from engaging the start button 1020 (or otherwise start the vehicle) when the transmission source 220 is only close to the vehicle 210, rather than actually inside the cabin 304. The cabin 304 may include a receptacle 1040 into which the transmission source 220 may be placed, but insertion of the transmission source 220 into the receptacle 1040 may not be required to use the start button 1020 to initiate the drive system 310 as long as the transmission source 220 is determined to be within the cabin 304.

As previously stated, the transmission source 220 may be a key or a key fob, but also may include another portable electronic device 1032 operable to generate a signal recognizable by the signal sensing devices 221-225 and the control system 215 as providing authorization to operate the vehicle 210. A suitable portable electronic device 1032 may include a smartphone, smartwatch, or other electronic device configured to generate a signal. Regardless of the device used to generate the signal, in various embodiments, the signal sensing devices 221-225 may be configured to enable operation of the drive system 310 until the portable electronic device 1032, configured to generate the signal of the transmission source 220, is positioned within the cabin 304 of the vehicle 210.

In various embodiments, the signal sensing devices 221-225 and the control system 215 may be responsive to a relative position of the transmission source within the cabin 304. Referring additionally to FIG. 11, when the transmission source 220 is placed in the receptacle 1040, the position of the transmission source 220 may be determined by the interior signal sensing device 225 by measuring the relative signal strength perceived by the interior signal sensing device 225 relative to the other signal sensing devices 222-225. As a result, inserting the transmission source 220 into the receptacle 1040 may activate the drive system 310 without the user having to engage the start button 1020 (or otherwise).

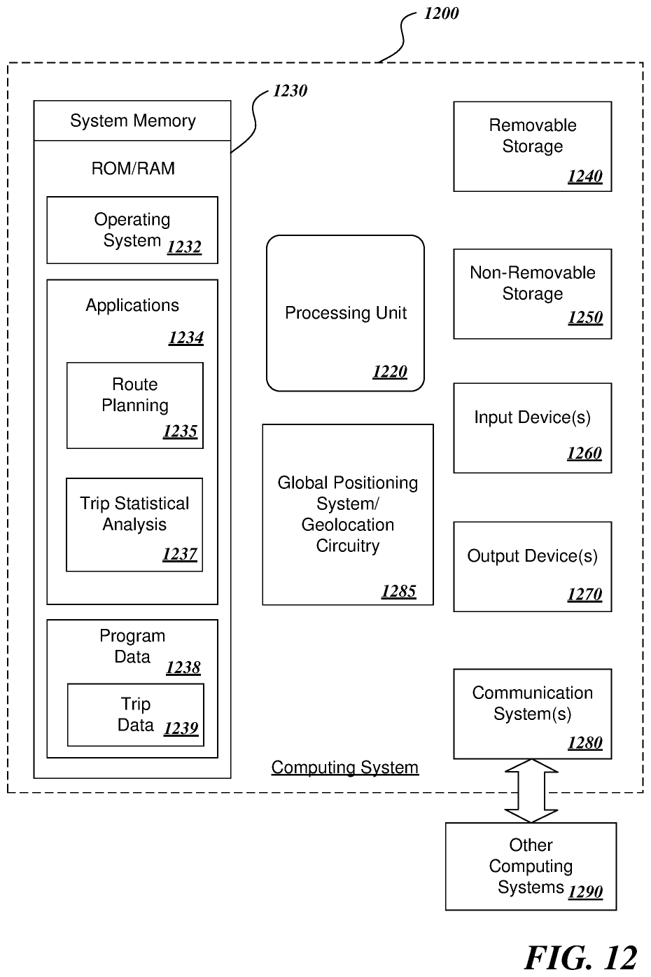

Referring to FIG. 12, and given by way of example only and not of limitation, some form of a generalized computing system 1200 may be used for the control system, such as the control systems 115 or 215 or the vehicle control system 315, that interoperates with the signal sensing devices (not shown in FIG. 12) to determine the relative signal strength of the transmission source 210 perceived by the signal sensing devices 221-225. In various embodiments, the computing system 1200 typically includes at least one processing unit 1220 and a system memory 1230. Depending on the exact configuration and type of computing system, the system memory 1230 may be volatile memory, such as random-access memory (“RAM”), non-volatile memory, such as read-only memory (“ROM”), flash memory, and the like, or some combination of volatile memory and non-volatile memory. The system memory 1230 typically maintains an operating system 1232, one or more applications 1234, and program data 1236. The operating system 1232 may include any number of operating systems executable on desktop or portable devices including, but not limited to, Linux, Microsoft Windows®, Apple OS®, or Android®, or a proprietary operating system.

The computing system 1200 may also have additional features or functionality. For example, the computing system 300 may also include additional data storage devices (removable and/or non-removable) such as, for example, magnetic disks, optical disks, tape, or flash memory. Such additional storage is illustrated in FIG. 3 by removable storage 1240 and non-removable storage 1250. Computer storage media may include volatile and non-volatile, removable and non-removable media implemented in any method or technology for storage of information, such as computer-readable instructions, data structures, program modules or other data. The system memory 330, the removable storage 340, and the non-removable storage 1250 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic disk storage or other magnetic storage devices, or any other medium which can be used to store the desired information and which can be accessed by the computing system 1200. Any such computer storage media may be part of the computing system 1200.

The computing system 1200 may also have input device(s) 1260 such as a keyboard, mouse, stylus, voice input device, touchscreen input device, etc. Output device(s) 1270 such as a display, speakers, printer, short-range transceivers such as a Bluetooth transceiver, etc., may also be included. The computing system 1200 also may include one or more communication systems 1280 that allow the computing system 1200 to communicate with other computing systems 1290, as further described below. Available forms of communication media typically carry computer-readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media. In further reference to FIG. 12, the computing system 1200 may include global positioning system (“GPS”) circuitry 1285 that can automatically discern its location based on relative positions to multiple GPS satellites. As described further below, GPS circuitry 1285 may be used to determine a location and generate data about acceleration, speed, braking, turning, and other movement of the vehicle 210.

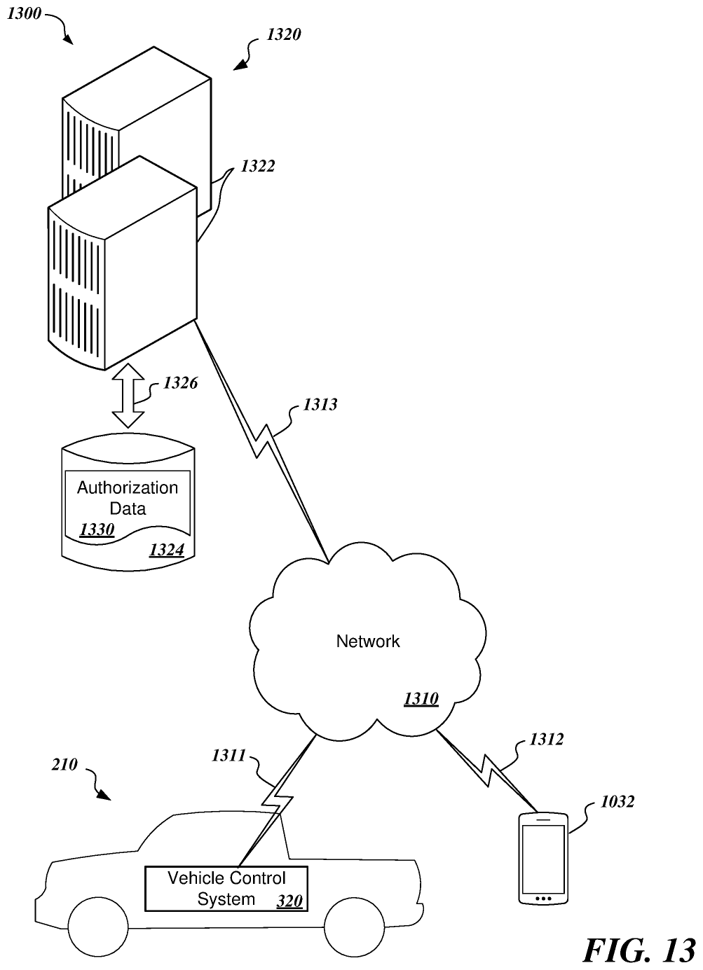

Referring additionally to FIG. 13, an operating environment 1300 of the vehicle 210 may include one or more remote computing systems 1320. The remote computing systems 1320 may be configured to communicate with the vehicle control system 315 of the vehicle 310 and/or a portable electronic device 1032 (FIG. 10) to manage authorization codes to determine which transmission sources are authorized to operate the vehicle 210. The vehicle control system 315, the portable electronic device 1032, and the remote computing system 1320 may communicate over a network 1310 via communications links 1311, 1312, 1313, and 1314, respectively. Because the vehicle 210 and the portable electronic device 1032 are movable devices, the communications links 1311 and 1312 generally may be wireless communications links, such as cellular, satellite, or Wi-Fi communications links. However, it will be appreciated that any or all of the systems may communicate over wireless or wired communications links. The remote computing system 1320 may include servers or server farms 1322. The remote computing system 1320 may access programming and data, such as vehicle authorization control data 1330, from a data storage devices 1324 over one or more high-speed channels 1326.

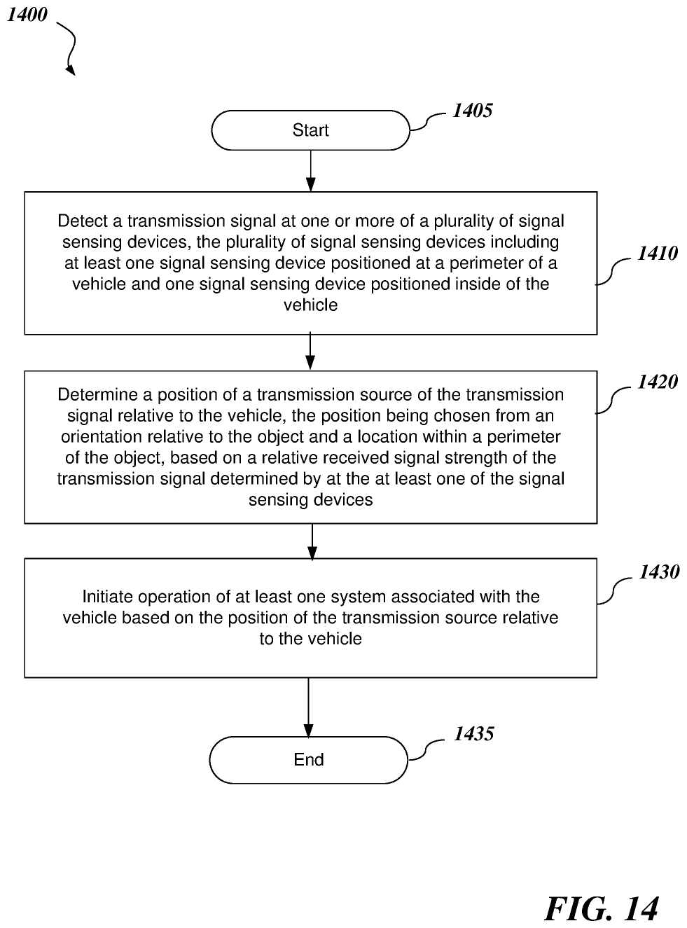

Referring additionally to FIG. 14, in various embodiments an illustrative method 1400 can selectively activate or deactivate subsystems associated with a vehicle based on a position of a transmission source relative to the vehicle. The method 1400 begins at a block 1405. At a block 1610, a transmission signal is detected at one or more of a plurality of signal sensing devices, the plurality of signal sensing devices including at least one signal sensing device positioned at a perimeter of a vehicle and one signal sensing device positioned inside of the vehicle. At a block 1620, a position of a transmission source of the transmission signal is determined relative to the vehicle based on a relative received signal strength of the transmission signal determined by at the at least one of the signal sensing devices. At a block 1630, operation of at least system associated with the vehicle is initiated based on the position of the transmission source relative to the vehicle. The method 1600 ends at a block 1635.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A system comprising:
a plurality of signal sensing devices positionable around an object, the signal sensing devices being configured to detect a transmission signal from a transmission source; and
a control system operably coupled with the plurality of signal sensing devices and configured to:
determine a position of the transmission source relative to the object, the position being chosen from an orientation relative to the object and a location within a perimeter of the object, based on a relative received signal strength of the transmission signal received by at least one of the plurality of signal sensing devices; and
initiate operation of at least one of a plurality of subsystems associated with the object based on the position of the transmission source relative to the object.

2. The system of claim 1, wherein:
the plurality of signal sensing devices includes Bluetooth sensors; and
the transmission source includes a Bluetooth transmitter.

3. The system of claim 1, wherein the transmission source includes a source chosen from a key, a key fob and a smartphone.

4. The system of claim 1, wherein the plurality of signal sensing devices includes:
a plurality of perimeter signal sensing devices positioned around the perimeter of the object; and
at least one internal signal sensing device configured to detect whether the transmission source is inside the object.

5. The system of claim 4, wherein:
the object includes a vehicle; and
the plurality of perimeter signal sensing devices includes at least four signal sensing devices positioned at four locations around the perimeter of the vehicle.

6. The system of claim 5, wherein the control system is further configured to unlock at least one vehicle door proximate to the position of the transmission source.

7. The system of claim 6, wherein the at least one vehicle door includes a door chosen from a cabin door and a cargo hatch.

8. The system of claim 5, wherein the control system is further configured to enable operation of a vehicle drive system in response to determining that the transmission source is inside of the vehicle.

9. The system of claim 1, wherein the control system is further configured to initiate a complementary operation of at least one of the plurality of subsystems associated with the object in response to determining that the transmission source is located outside of a predetermined range of the object.

10. The system of claim 9, wherein the complementary operation includes at least one operation chosen from locking a door, disabling at least one of the plurality of subsystems, and powering off at least one of the plurality of subsystems.

11. A vehicle comprising:
a vehicle body;
a cabin configured to receive contents chosen from at least one occupant and cargo;
a drive system configured to motivate, accelerate, decelerate, stop, and steer the vehicle; and
a proximity response system including:
a plurality of signal sensing devices positionable around the vehicle, the signal sensing devices being configured to detect a transmission signal from a transmission source; and
a control system operably coupled with the plurality of signal sensing devices and configured to:
determine a position of the transmission source relative to the vehicle based on a relative received signal strength of the transmission signal received by at least one of the plurality of signal sensing devices; and
initiate operation of at least one of a plurality of subsystems associated with the vehicle based on the position of the transmission source relative to the vehicle.

12. The vehicle of claim 11, wherein the plurality of signal sensing devices includes Bluetooth sensors and the transmission source includes a Bluetooth transmitter.

13. The vehicle of claim 11, wherein the transmission source includes a source chosen from a key, a key fob and a smartphone.

14. The vehicle of claim 11, wherein the plurality of signal sensing devices includes:
a plurality of perimeter signal sensing devices positioned around the perimeter of the vehicle; and
at least one internal signal sensing device configured to detect whether the transmission source is inside the vehicle.

15. The vehicle of claim 1, wherein control system is further configured to unlock at least one vehicle door proximate to the position of the transmission source.

16. The vehicle of claim 15, wherein the at least one vehicle door includes a door chosen from a cabin door and a cargo hatch.

17. The vehicle of claim 14, wherein the control system is further configured to enable operation of the drive system in response to determining that the transmission source is inside of the cabin.

18. The vehicle of claim 11, wherein the control system is further configured to initiate a complementary operation of at least one of the plurality of subsystems associated with the vehicle in response to determining that the transmission source is located outside of a predetermined range of the vehicle.

19. The vehicle of claim 18, wherein the complementary operation includes at least one operation chosen from locking a door, disabling at least one of the plurality of subsystems, and powering off at least one of the plurality of subsystems.

20. A method comprising:
detecting a transmission signal at one or more of a plurality of signal sensing devices, the plurality of signal sensing devices including at least one signal sensing device positioned at a perimeter of a vehicle and one signal sensing device positioned inside of the vehicle;
determining a position of a transmission source of the transmission signal relative to the vehicle, the position being chosen from an orientation relative to the vehicle and a location within a perimeter of the vehicle, based on a relative received signal strength of the transmission signal determined by at the at least one of the plurality of signal sensing devices; and
initiating operation of at least one of a plurality of subsystems associated with the vehicle based on the position of the transmission source relative to the vehicle.
